(19) United States
(12) Patent Application Publication
(10) Pub. No.: US 2014/0144732 A1
(43) Pub. Date: May 29, 2014

(54) Pedal Travel Simulator, Actuating Unit for a Hydraulic Brake System and Brake System

(71) Applicant: Continental Teves AG & Co., oHG, Frankfurt (DE)

(72) Inventors: Ronald Bayer, Mühlheim/Main (DE); Johann Jungerbecker, Badenheim (DE); Stefan A. Drumm, Saulheim (DE); Johannes Görlach, Langgöns (DE); Marco Besier, Ba Schwalbach (DE); Lothar Schiel, Hofheim (DE); Alfred Eckert, Mainz-Hechtsheim (DE)

(73) Assignee: Continental Teves AG & Co. oHG, Frankfurt (DE)

(21) Appl. No.: 14/115,230

(22) PCT Filed: Apr. 11, 2012
(86) PCT No.: PCT/EP2012/056492

§ 371 Date: Dec. 20, 2013

(30) Foreign Application Priority Data
May 2, 2011 (DE) 10 2011 075 075.4
May 2, 2011 (DE) 10 2011 075 076.2
Feb. 29, 2012 (DE) 10 2012 203 099.9

(51) Int. Cl. B60T 7/04; B60T 11/20; B60T 13/62

(52) U.S. Cl. CPC B60T 7/04; B60T 13/62; B60T 11/203
USPC 188/106 P; 303/14; 60/561

(57) ABSTRACT

The invention relates to a pedal travel simulator for the hydraulic connection to a pressure chamber of a master brake cylinder of a hydraulic brake system, in particular for motor vehicles, having a housing and a simulator piston that is diplaceably mounted in the housing, wherein the simulator piston delimits a first hydraulic simulator chamber together with the housing, which simulator chamber can accommodate pressurizing media. Wherein an elastic restoring means acts on the simulator piston, wherein the pedal travel simulator includes a second hydraulic simulator chamber for accommodating pressurizing media, the simulator chamber being delimited by an elastically deformable membrane. The invention further relates to an actuating unit for a hydraulic motor vehicle brake system of the brake-by-wire type, and to a hydraulic motor vehicle brake system.

### CROSS REFERENCE TO RELATED APPLICATIONS

This application claims priority to German Patent Application Nos. 10 2011 075 076.2, filed May 2, 2011, 10 2011 075 075.4, filed May 2, 2011, 10 2012 203 099.9, filed on Feb. 29, 2012, and PCT/EP2012/056492, filed Apr. 11, 2012.

### FIELD OF THE INVENTION

This invention relates to a pedal travel simulator, and to an actuating unit for a hydraulic motor-vehicle brake system, and to a hydraulic motor-vehicle brake system having a pedal travel simulator of this type.

### BACKGROUND

Hydraulic vehicle brake systems are known which are configured as power-assisted brake systems and include, in addition to a brake master cylinder which can be actuated by muscular force exerted by the driver, to which wheel brakes are connected hydraulically, and which provides pressure and volume for actuating wheel brakes, a further, electrically controllable pressure and volume provision device which actuates the wheel brakes in a “brake-by-wire” operating mode. An actuation of the brake system by way of the muscular force of the vehicle driver (fallback operating mode) is effected only if the electrically controllable pressure and volume provision device fails. In power-assisted brake systems, pedal travel simulators are used which impart a familiar brake pedal feeling to the vehicle driver in the “brake-by-wire” operating mode.

WO 2011/029812 A1 has disclosed an electrohydraulic brake system having a brake master cylinder which can be actuated by muscular force and to the first pressure space of which a hydraulic pedal travel simulator can be connected. The pedal travel simulator includes a simulator piston which separates a simulator chamber from a simulator spring chamber. The simulator chamber can be connected hydraulically to the first pressure space of the brake master cylinder. A simulator spring, on which the simulator piston is supported, is arranged in the simulator spring chamber. It is considered disadvantageous in the case of the brake system that the force-displacement characteristic produced during a driver actuation can have one or more discontinuities, that is to say force jumps, on account of frictional forces, stick-slip effects and/or prestressing forces of the individual elements of the brake master cylinder and pedal travel simulator. Such discontinuities occur, in particular, in the case of low pedal forces, that is to say in a low force range, in which discontinuities in the pedal feeling are considered to be particularly disruptive or unpleasant by the driver.

The present invention is therefore based on the object of providing a pedal travel simulator, an actuating unit for a hydraulic motor-vehicle brake system, and a hydraulic motor-vehicle brake system having an actuating unit of this type, which imparts an improved force-displacement characteristic, in particular one which is considered to be continuous, to the driver, above all in the range of low pedal travels and/or pedal forces. The pedal travel simulator and the actuating unit are intended to impart a pleasant brake pedal feeling to the driver and not to exhibit any force jump, in particular when the simulator piston “breaks away”, which force jump can be discerned as an undesired jolt at the brake pedal. Furthermore, the pedal travel simulator should be of structurally simple configuration and should be capable of being produced inexpensively.

According to the invention, this object is achieved by way of a pedal travel simulator, an actuating unit, and a brake system as described herein.

### SUMMARY AND INTRODUCTORY DESCRIPTION

The invention is based on the concept that the pedal travel simulator includes a second hydraulic simulator space for receiving pressure medium, which second hydraulic simulator space is delimited by an elastically deformable diaphragm. The second simulator space represents an additional pressure-medium volume receptacle which responds without jolts and by way of which any force jumps in the force-displacement characteristic induced by the first simulator space which is delimited by the simulator piston which is loaded by way of the restoring means are smoothed, as it were.

The first and the second simulator space are preferably connected hydraulically in parallel, with the result that the main proportion of the force-displacement characteristic of the pedal travel simulator is contributed by the first simulator space which is delimited by the simulator piston which is loaded by way of the restoring means, which is possible simply by way of suitable design of the restoring means, and the pedal feeling is optimized by way of the second simulator space which receives volume in a manner which is free from response force, and which second simulator space can be of correspondingly smaller design.

The deformation of the diaphragm is preferably delimited spatially by at least one delimiting contour of a diaphragm supporting body. In order to achieve a compact overall design, the diaphragm supporting body is formed in the simulator piston.

It is preferred that the maximum receiving volume of the second simulator space is defined by the delimiting contour of the diaphragm supporting body or the simulator piston. As a result, the effect of the second simulator space as pressure-medium receiving volume can be limited to the range of small pressures, that is to say a response range of the force-displacement characteristic.

The diaphragm supporting body (or the simulator piston) and the diaphragm advantageously delimit a receiving space which is reduced in size by the expansion/deformation of the diaphragm depending on the pressure, until the diaphragm comes into contact with the delimiting contour of the diaphragm supporting body. The receiving space is advantageously connected to atmospheric pressure. To this end, the receiving space itself can be connected directly to atmospheric pressure and/or can be connected via at least one connecting line to a space, for example the space, in which the restoring means is arranged, which space is connected to atmospheric pressure.

According to one development of the invention, the elastic restoring means is arranged in a space which is delimited by the simulator piston and the housing and which is sealed with respect to the first simulator space, said space also being connected to atmospheric pressure. To this end, the space itself can be connected directly to atmospheric pressure and/or can be connected via at least one connecting line to the receiving space which is connected to atmospheric pressure. Because the pedal-side face of the brake master cylinder is likewise loaded with atmospheric pressure, it is ensured that the function of the actuating unit is independent of the value of the prevailing atmospheric pressure.

For a homogeneous force-displacement characteristic, the first and the second simulator space are preferably connected hydraulically to one another via at least one connecting line.

According to one preferred embodiment of the pedal travel simulator according to the invention, said pedal travel simulator includes two spatially separated units, the first unit including the first simulator space and the simulator piston and the second unit including the second simulator space and the elastically deformable diaphragm. For a compact overall design, the two units are particularly preferably arranged in a common housing.

The two units are preferably connected hydraulically in parallel, in order to achieve the smoothing of force jumps during the receiving of pressure medium in the first simulator space.

The second unit advantageously includes a cavity, in which the diaphragm and a diaphragm supporting body with a delimiting contour for the diaphragm are arranged, the diaphragm separating the second simulator space from a receiving space which is arranged between the diaphragm supporting body and the diaphragm.

According to another preferred embodiment of the pedal travel simulator according to the invention, the second simulator space is arranged in a cavity of the simulator piston. The pedal travel simulator can thus be configured in one single unit. Here, the second simulator space is particularly preferably arranged in a region of the simulator piston, which region lies opposite the restoring means, as a result of which the arrangement of connecting channels between spaces is simplified and the requirement for installation space is reduced.

The second simulator space is preferably delimited by the diaphragm which is arranged in the simulator piston and a piston face cover of the simulator piston. The production of the pedal travel simulator is simplified by way of a piston face cover. The mounting of the diaphragm and the piston face cover in the simulator piston takes place particularly preferably by way of being pressed into the simulator piston.

Here, the abovementioned hydraulic connection between the simulator spaces is preferably realized by means of a connecting channel which is arranged in the piston face cover.

A delimiting contour is preferably formed on the piston face cover, against which delimiting contour the diaphragm bears substantially in a non-actuated state of the pedal travel simulator. The force-displacement characteristic of the pedal travel simulator can be influenced by way of the shaping of the delimiting contour.

According to one development of the invention, a receiving space is situated in the cavity of the simulator piston, which receiving space is delimited by the diaphragm and a delimiting contour which is formed in the simulator piston. The diaphragm can therefore be deformed by the receiving space being reduced in size and the second simulator space being increased in size, until the maximum receiving volume of the second simulator space is reached when the diaphragm is in contact with the delimiting contour.

At least one further connecting channel is preferably arranged in the simulator piston, via which further connecting channel the receiving space is connected to a space which receives the elastic restoring means, in order to ensure pressure equalization between the receiving space and the space which receives restoring means, and in order to ensure the connection to atmospheric pressure, which connection is necessary for functioning.

The invention also relates to an actuating unit for a hydraulic motor-vehicle brake system of the “brake-by-wire” type having a brake master cylinder which can be actuated by means of a brake pedal with at least one pressure space, to which wheel brakes can be connected hydraulically, and a pedal travel simulator according to the invention and a hydraulic motor-vehicle brake system having an actuating unit of this type.

According to one development of the actuating unit or the motor-vehicle brake system, a switching device is provided in the hydraulic connection between the, for example first, pressure space of the brake master cylinder and the pedal travel simulator, which switching device connects the first and second simulator space in the “brake-by-wire” operating mode as a result of its activation to the pressure space of the brake master cylinder, and disconnects said first and second simulator space outside the “brake-by-wire” operating mode by way of termination of the activation.

In order to make non-damped release of the brake pedal in the “brake-by-wire” operating mode and emptying of the simulator spaces in the non-actuated state of the brake pedal possible, the switching device is preferably formed by an electrically actuable adding valve and a nonreturn valve which is connected in parallel to the adding valve and opens in the direction of the brake master cylinder. In order that the pedal travel simulator is inactive in the de-energized fallback level, the adding valve is advantageously configured so as to be closed in the de-energized state.

One advantage of the invention lies in an inexpensive improvement of the brake pedal characteristic of an actuating unit for a hydraulic motor-vehicle brake system. The force-displacement characteristic of known actuating units which is often criticized by drivers as being discontinuous in the case of small pedal travels is harmonized.

Further advantageous developments of the invention can be gathered from the further description and drawings.

### BRIEF DESCRIPTION OF THE DRAWINGS

Further features, advantages and preferred embodiments of the invention result from the following description using figures, in which, diagrammatically:

FIG. 1 shows one exemplary embodiment of an actuating unit according to the invention having a first exemplary embodiment of a pedal travel simulator according to the invention,

FIG. 2 shows part of the pedal travel simulator of the first exemplary embodiment in an exploded illustration,

FIG. 3 shows a second exemplary embodiment of a pedal travel simulator according to the invention in a non-actuated state, and

FIGS. 4a-4c show the exemplary pedal travel simulator from FIG. 3 in various actuating states.

### DETAILED DESCRIPTION

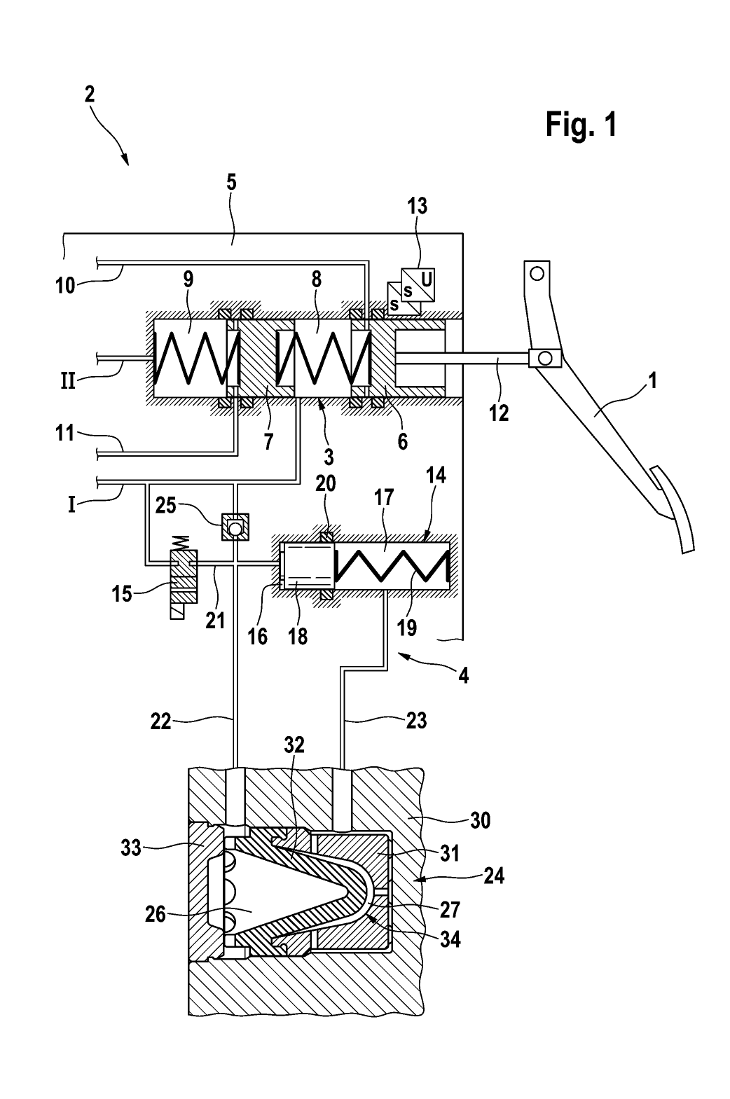

FIG. 1 shows, in a greatly diagrammatic manner, an exemplary actuating unit 2 for a hydraulic motor-vehicle brake system of the “brake-by-wire” type or a hydraulic power-assisted brake system. The actuating unit 2 includes a dual-circuit brake master cylinder or tandem master cylinder 3 which can be actuated by means of an actuating or brake pedal 1, and a pedal travel simulator 4 which interacts with the brake master cylinder 3. The brake master cylinder 3 comprises two pistons 6, 7 which are arranged one behind another in a housing 5 and delimit two hydraulic pressure spaces 8, 9. In an exemplary motor-vehicle brake system, the pressure spaces 8, 9 are connected firstly via radial bores which are formed in the pistons 6, 7 and corresponding pressure equalization lines 10, 11 to a pressure-medium reservoir (not shown), it being possible for said connections to be shut off by way of a relative movement of the pistons 8, 9 in the housing 5. Secondly, the pressure spaces 8, 9 are connected to the wheel brakes (not shown) of the brake system by means of hydraulic lines I, II, advantageously with the interconnection of one separating valve, for example open in the de-energized state, per brake circuit and/or wheel-individual electrically controllable pressure modulation valves (for example, one inlet and one outlet valve per wheel brake). Each brake circuit I, II is preferably assigned two hydraulically actuable wheel brakes. Furthermore, the pressure spaces 8, 9 receive restoring springs which are not denoted in greater detail and position the pistons 6, 7 in a starting position when the brake master cylinder 3 is non-actuated. A piston rod 12 couples the pivoting movement of the brake pedal 1 as a consequence of a pedal actuation to the translatory movement of the first (master-cylinder) piston 6, the actuation travel of which is detected by a displacement sensor 13 of preferably redundant configuration. As a result, the corresponding piston displacement signal is a measure of the brake-pedal actuating angle. It represents a braking request of a vehicle driver.

Furthermore, the exemplary motor-vehicle brake system (not shown) includes an electrically controllable pressure source which can be connected hydraulically to the brake circuits or wheel brakes of the brake system. The electrically controllable pressure source is preferably configured as a hydraulic cylinder/piston arrangement or as a single-circuit electrohydraulic actuator, the piston of which can be actuated by an electric motor with a rotation/translation gear mechanism being connected in between. In a normal braking function of the brake system (“brake-by-wire” operating mode), the brake master cylinder 3, and therefore the vehicle driver, are decoupled from the wheel brakes by closing of the separating valves and a simulator release valve 15 is activated which connects the pedal travel simulator 4 to the brake master cylinder 3. The pedal travel simulator 4 which interacts with the brake master cylinder 3 then imparts a pleasant pedal feeling to the vehicle driver. The brake circuits are connected to the pressure source which provides the brake pressure for actuating the wheel brakes.

According to the example, the pedal travel simulator 4 can be coupled hydraulically via the electrically actuable simulator release valve 15 to the first pressure space 8 of the brake master cylinder 3. However, it is also possible that the two pressure spaces 8, 9 of the brake master cylinder are designed such that they can be connected hydraulically to the pedal travel simulator, or that in each case one pedal travel simulator is connected to each of the two pressure spaces. The pedal travel simulator 4 can be switched on and off by means of the simulator release valve 15. In the case of a brake pedal actuation and an activated (open) simulator release valve 15 (for example, in the “brake-by-wire” operating mode), pressure medium flows from the master-cylinder pressure space 8 into at least one of the hydraulic simulator spaces 16 and 26 of the pedal travel simulator 4 which will be described in the following text. The pedal feeling (haptic) which is generated in the process depends on the counterpressure which is built up in the simulator 4 and on the throttle properties of the activated simulator release valve 15. Independently of the switching state of the simulator release valve 15 and independently of its throttle action, a nonreturn valve (check valve) 25 which is arranged hydraulically antiparallel to the simulator release valve 15 makes it possible for the pressure medium to flow back in a largely unimpeded manner from the simulator spaces 16, 26 to the master-cylinder pressure space 8. The undamped release of the brake pedal 1 which results therefrom is considered to be pleasant. Without this function, the impression of what are known as “sticking” brakes might occur.

According to the first exemplary embodiment (shown in FIG. 1) of a pedal travel simulator, the pedal travel simulator 4 is of two-piece configuration. A first unit 14 consists substantially of a simulator space 16, a simulator spring space 17 and a simulator piston 18 which separates the two spaces 16, 17 from one another, it being possible for the simulator space 16 to be connected to the pressure space 8 by means of the simulator release valve 15. According to the example, the simulator piston 18 is guided in the housing 5 and, together with the housing 5, delimits the simulator space 16 and the simulator spring space 17. The simulator piston 18 is supported on the housing 5 by an elastic element 19 (for example, a spring) which is arranged in the simulator spring space 17 and is advantageously prestressed. In the case of the simulator unit 14, the force-displacement characteristic which is produced (pedal characteristic sensed by the driver, pedal force as a function of the pedal travel) is defined substantially by the spring characteristic of the elastic element 19, but also, for example, by frictional forces of the simulator piston 18 or the pistons 6, 7. It has been shown that, if only the unit 14 is used, certain discontinuities (force jumps) as a result of the response behavior of the simulator spring 19 (for example, spring prestress which is set to be too high), the friction of the simulator piston 18 in the housing 5 and stick-slip effects of the piston sealing ring 20 result in the initial range of the pedal characteristic which is discerned in a highly sensitive manner by the driver, that is to say in the case of small pedal forces.

According to the first exemplary embodiment, the pedal travel simulator 4 therefore includes a second unit 24. The unit 24 represents a volume consumer which responds without jolts and is connected to the simulator circuit 21. The unit 24 leads to smoothing of the force jumps and therefore to a force-displacement characteristic which is considered to be continuous by the driver. The unit 24 includes a second hydraulic simulator space 26 for receiving pressure medium, which second hydraulic simulator space 26 is delimited by a deformable diaphragm 32.

As can be gathered from FIG. 1, the simulator unit 24 comprises substantially a housing 30 which can also be configured in one piece with the housing 5, with a cavity which is, for example, cylindrical and is divided into two spaces 26, 27 by the elastically deformable diaphragm 32. The hydraulic simulator space 26 is connected hydraulically via the line 22 to the simulator circuit 21, and therefore also to the simulator space 16 of the unit 14. The simulator unit 24 is connected hydraulically in parallel as a volume consumer of the simulator unit 14, which volume consumer responds without jolts, and is integrated into the simulator circuit 21 which is connected to the brake master cylinder 3 via the simulator release valve 15 in the “brake-by-wire” operating mode. According to the example, the displacement-volume receiving space 27 is connected via the line 23 to the simulator spring space 17 of the unit 14 and its ventilating connection (not shown in FIG. 1) is connected to atmosphere. A cover 33 which delimits the simulator space 26 on one side makes it possible to mount the unit 24. A diaphragm supporting body 31 is arranged in the receiving space 27, the inner contour 34 of which diaphragm supporting body 31 is suitable for at least partial contact with the diaphragm 32. The diaphragm 32 and the inner contour 34 of the diaphragm supporting body 31 are designed in such a way that the receiving volume of the simulator space 26 and the associated simulator pressure behave in accordance with the desired force-displacement characteristic. This behavior is achieved by the shaping design of the diaphragm 32 and the inner contour 34.

At the beginning of a braking operation in the “brake-by-wire” operating mode, pressure medium which is displaced from the pressure space 8 is first of all received in the hydraulic simulator space 26 of the simulator unit 24, the deformable diaphragm 32 expanding more and more. Furthermore, pressure medium is received from the first and second simulator space 16 and 26. When the outer contour of the diaphragm 32 comes into contact with the inner contour 34 of the diaphragm supporting body 31, the maximum pressure medium volume which can be received by the volume consumer 24 is reached. No further receiving of volume by the unit 24 is possible. The displaced pressure medium is then only received by the first simulator space 16 of the simulator unit 14. Furthermore, the force-displacement characteristic is then defined for pedal travels which become greater by the simulator spring 19 of the unit 14. As a result of the integration of second unit 24 which responds without jolts, with a simulator space 26 which is delimited by an elastic diaphragm 32, into the pedal travel simulator 4, the discontinuous force-displacement characteristic, often criticized by drivers, of the actuating unit 2 is harmonized in the initial range (small pedal travels) and is improved as a result. The measures according to the invention are simple and inexpensive to produce.

The deformable diaphragm is preferably formed by an elastomeric diaphragm. Other diaphragm solutions, for example a metal diaphragm, are likewise conceivable, however.

The pedal travel simulator 4 can also be configured as an independent module.

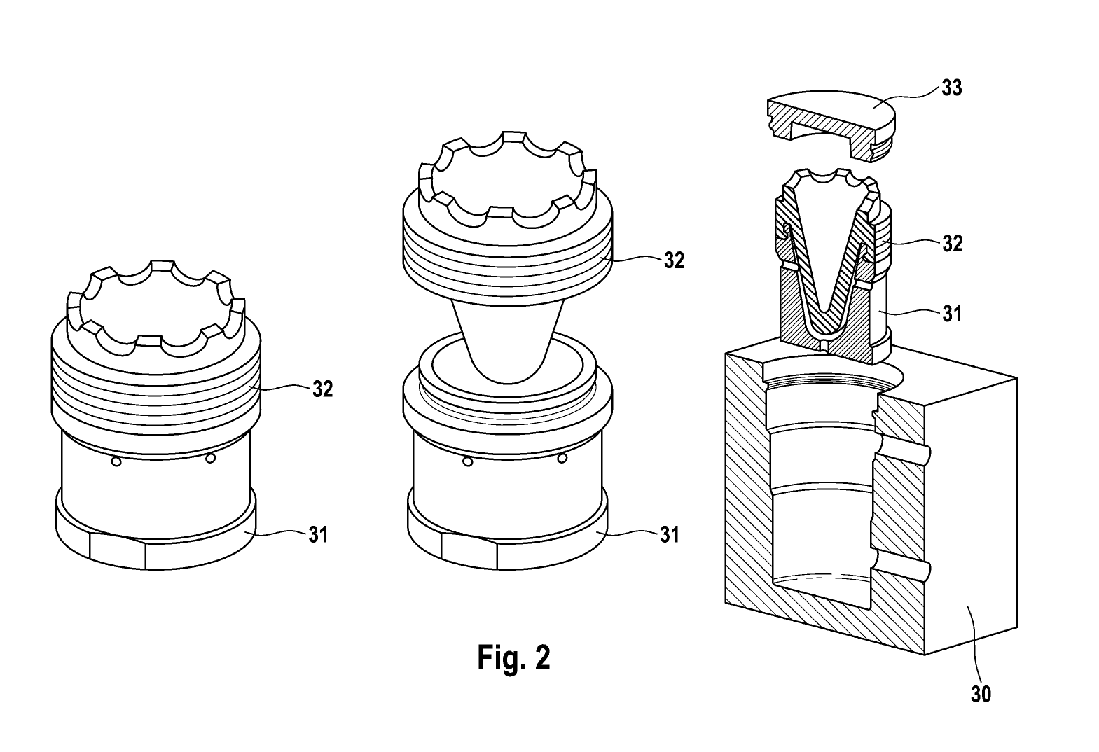

FIG. 2 depicts the unit 24 of the pedal travel simulator 6 from FIG. 1 in an exploded illustration. The diaphragm supporting body 31, the elastically deformable diaphragm 32 and the cover 33 are arranged one after another in a bore in the housing 30.

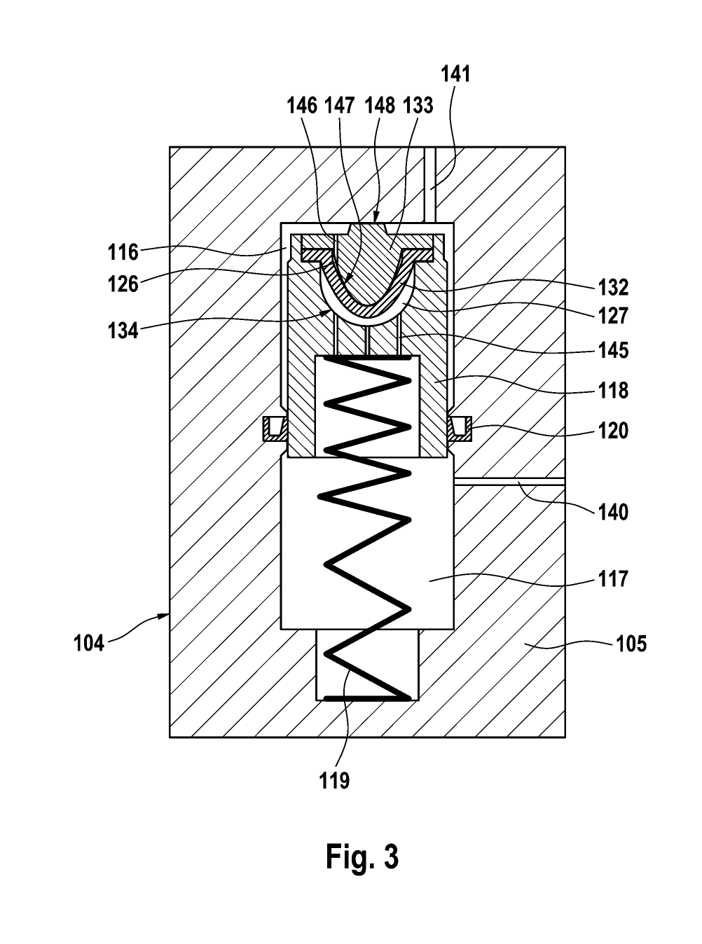

FIG. 3 diagrammatically shows a second exemplary embodiment of a pedal travel simulator. The pedal travel simulator is situated in a non-actuated state. The pedal travel simulator 104 comprises a housing 105 which receives a simulator piston 118 in a bore which is, for example, stepped. According to the example, the simulator piston 118 has a smooth cylinder surface which interacts with a sealing ring 120 which is fixed to the housing. The sealing ring 120 divides the bore into a first simulator space 116 and a simulator spring space 117, the simulator spring space 117 receiving a nonlinear simulator spring 119 which corresponds to the desired, advantageously progressive, force-displacement characteristic (simulator characteristic curve). The simulator spring space 117 is connected via a ventilating connection 140 to atmospheric pressure and is filled either with air or with pressure medium (under atmospheric pressure=“pressureless”). The simulator space 116 can be connected via a hydraulic connection 141 to, for example, a brake master cylinder (not shown) which can be actuated by the brake pedal, with the result that the simulator space 116 can receive pressure medium from a pressure space of the brake master cylinder. Here, the volume of the first simulator space 116 changes as a result of a displacement of the simulator piston 118 relative to the housing 105. In its pressureless rest position (pressure in the hydraulic connection 141 is equal to the pressure in the ventilating connection 140), the simulator piston 118 is pressed on the end side onto a stop in the housing 105 by the simulator spring 119. In order to avoid a “slack” pedal feeling during release of the brake pedal, the prestressing force of the simulator spring 119 is usually selected to be sufficiently great. This has the consequence that, during actuation of the brake pedal, first of all pressure has to be built up, the force action of which on the simulator piston 118 overcomes the prestressing force of the simulator spring 119 and the static friction force of the sealing ring 120 before the pedal travel simulator 104 receives pressure medium volume in the simulator space 116. In known simulator brake systems, this “breakaway” of the simulator piston 118 can be sensed as an undesired jolt in the brake pedal.

In order to improve the response behavior of the pedal travel simulator 104 and in order to avoid the above-described breakaway effect, an additional volume receptacle which responds without jolts is arranged in the simulator piston 118. Said volume receptacle is configured as a second simulator space 126, the volume of which can be changed as a result of the deformation of a diaphragm 132 which is produced from an elastic material. The deformation of an elastic diaphragm 132 takes place practically without hysteresis, that is to say without causing the undesired jolt in the brake pedal. According to the second exemplary embodiment, the deformable diaphragm is therefore integrated into the simulator piston.

The diaphragm 132 separates the simulator space 126 from a displacement-volume receiving space 127 in the simulator piston 118. The receiving space 127 is pressureless, since it is connected via one or more ventilating channels 145 to the simulator spring space 117. The second simulator space 126 is connected via at least one connecting channel 146 to the first simulator space 116.

According to the example, the fastening of the diaphragm 132 in the simulator piston 118 takes place by way of a piston face cover 133 which is pressed into the end side of the simulator piston 118 and, together with the diaphragm 132, delimits the simulator space 126. As a result of being pressed in, the diaphragm 132 is fixed at its outer circumference in an annularly pressure-tight manner. A stop face 148 which interacts with the housing 105 and the connecting channel 146 from the first simulator space 116 to the second simulator space 126 are formed in the piston face cover 133. Furthermore, the piston face cover 133 has a pin-shaped rotary contour 147 toward the second simulator space 126, on which rotary contour 147 the diaphragm 132 lies at least partially in the pressureless (non-actuated) state of the simulator 104, with the result that the volume of the second simulator space 126 assumes the value zero or virtually zero in this state.

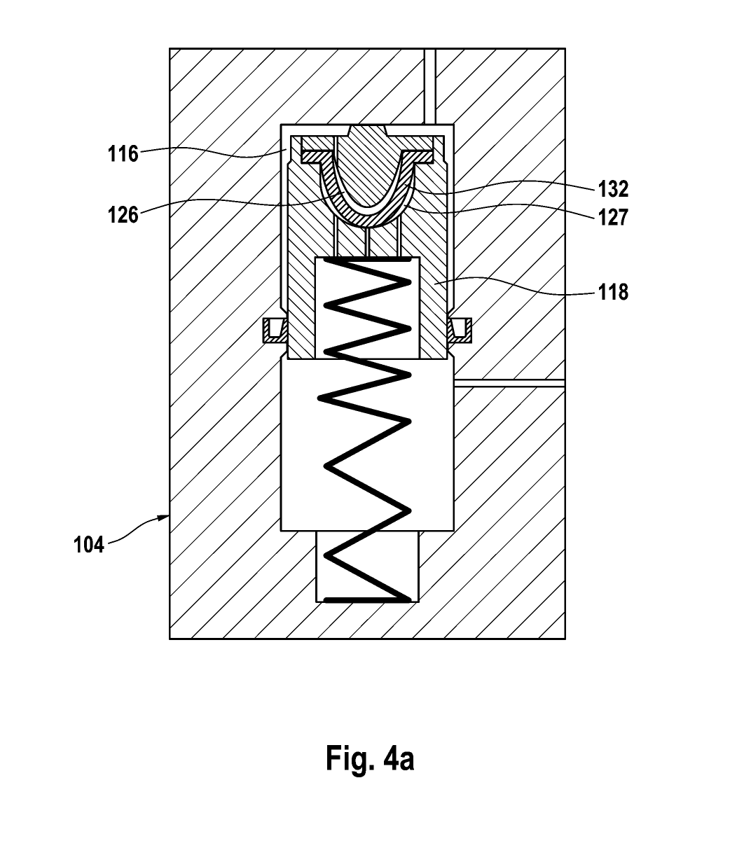

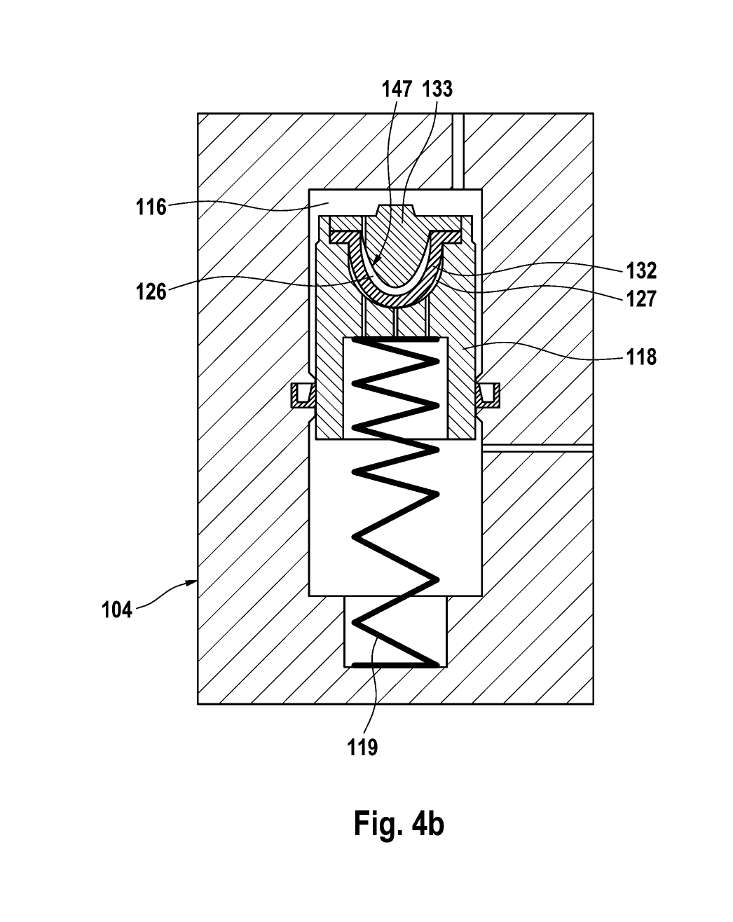

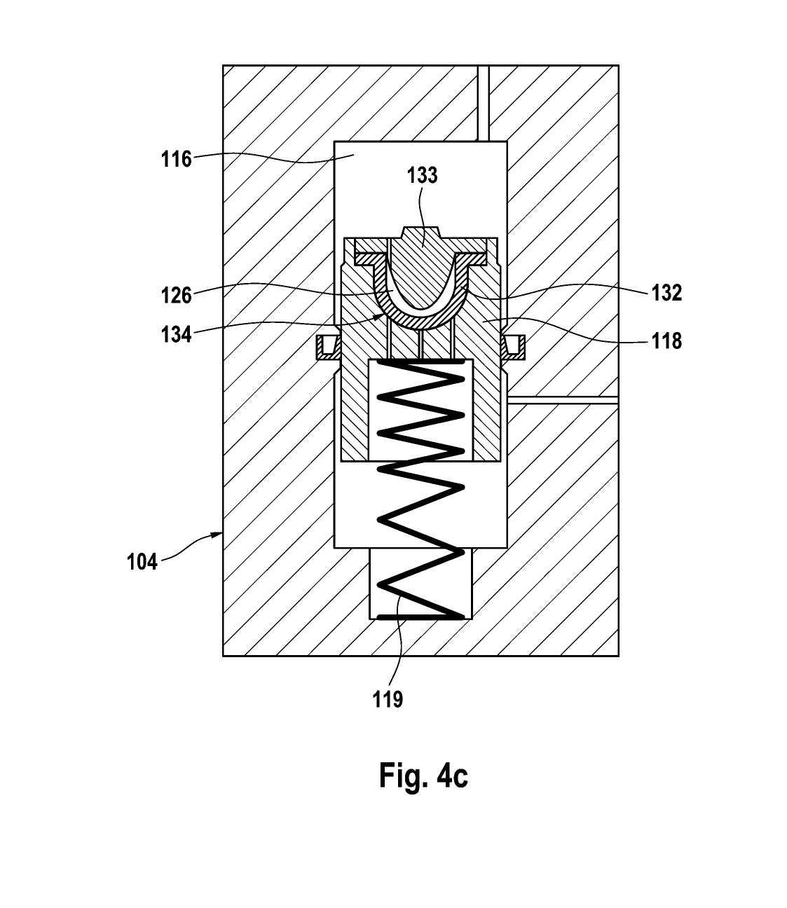

FIG. 4a-4c show the pedal travel simulator 104 according to the example in various actuating states. If the pedal travel simulator 104 is actuated, first of all, as shown in FIG. 4a, the diaphragm 132 is deformed, that is to say pressure medium is received in the second simulator space 126. The diaphragm 132 moves into the pressureless receiving space 127, the filling volume of which (air or pressure medium) is displaced in the process through the ventilating channels 145 which lead to the simulator spring space 117. FIG. 4a therefore shows the pedal travel simulator 104 in the transitional phase of the gentle start of receiving volume to the breakaway of the simulator piston 118.

In the case of a further actuation of the brake pedal, both the first and the second simulator space 116 and 126 receive pressure medium. Accordingly, FIG. 4b shows the pedal travel simulator 104 with displaced simulator piston 118 with the diaphragm 132 not yet completely in contact with a hollow contour 134 in the simulator piston 118.

When the volume of the receiving space 127 reaches the value zero or the simulator space 126 has reached its maximum possible receiving volume, the diaphragm 132 is in contact with the corresponding hollow contour 134 in the simulator piston 118. In this exemplary embodiment, the simulator piston 118 therefore acts as a diaphragm supporting body. Receiving of volume then takes place exclusively in the first simulator space 116 by movement of the simulator piston 118. This state of the pedal travel simulator 104 at relatively high pressure is shown in FIG. 4c.

The desired effect of the gentle transition from the pressureless state of the simulator 104 to an operating state, in which the stop face 148 of the simulator piston 118 has been detached from the housing 105, can be predefined by way of the shaping of the movement-delimiting contours 147, 134 for the diaphragm 132.

As a result of the arrangement of the second simulator space 126 in order to provide the additional volume receptacle in the simulator piston 118 according to the second exemplary embodiment, which additional volume receptacle responds without jolts, no further bore is required in the housing 105 to connect the two simulator spaces in contrast to the first exemplary embodiment.

Moreover, the structural complexity is minimized by way of the combination of the rotary parts simulator piston 118, osculating contours 134, 147 and clamping in of the responding diaphragm 132 according to the second exemplary embodiment in one component.

The pedal travel simulator 104 according to the second exemplary embodiment is also preferably used in an actuating unit or a hydraulic brake system of the “brake-by-wire” type, as have been explained in conjunction with FIG. 1. Here, the pedal travel simulator 104 can advantageously be connected via an electromagnetically actuable simulator release valve which is, in particular, closed in the de-energized state (i.e. normally closed) and is arranged in a hydraulic connection between a pressure space of the brake master cylinder and the hydraulic connection 141 of the pedal travel simulator 104.

While the above description constitutes the preferred embodiment of the present invention, it will be appreciated that the invention is susceptible to modification, variation, and change without departing from the proper scope and fair meaning of the accompanying claims.

1. A pedal travel simulator (4, 104) for hydraulic connection to a pressure space (8) of a brake master cylinder (3) of a hydraulic brake system for motor vehicles, comprising a pedal travel simulator (4, 104) having a housing (5, 30, 105) and a simulator piston (18, 118) which is mounted displaceably in the housing, the simulator piston delimiting together with the housing a first hydraulic simulator space (16, 116) which can receive a pressure medium, the simulator piston (18, 118) being loaded by an elastic restoring means (19, 119), a second hydraulic simulator space (26, 126) for receiving pressure medium, the second hydraulic simulator space (26, 126) delimited by an elastically deformable diaphragm (32, 132).

2. The pedal travel simulator as claimed in claim 1, further comprising in that a deformation of the diaphragm (32, 132) is delimited limited spatially by at least one delimiting contour (34, 134, 147) of a diaphragm supporting body (31, 118, 133) integrated with the simulator piston (118).

3. The pedal travel simulator as claimed in claim 2, further comprising in that the diaphragm supporting body (31, 118), the simulator piston (118), and the diaphragm (32, 132) delimit a receiving space (27, 127) which is connected to atmospheric pressure.

4. The pedal travel simulator as claimed in claim 3, further comprising in that the elastic restoring means (19, 119) is arranged in a second space (17, 117) which is delimited by the simulator piston (18, 118) and the housing (5, 105) and which is sealed (20, 120) with respect to the first simulator space (16, 116), the second space (17, 117) being connected to atmospheric pressure or being connected via at least one connecting line (23, 145) to the receiving space (27, 127) which is connected to atmospheric pressure.

5. The pedal travel simulator as claimed in claim 1 further comprising at least one connecting line (22, 146), by way of which the first and the second simulator space (16, 26; 116, 126) are connected hydraulically to one another.

6. The pedal travel simulator as claimed in claim 1 further comprising in that the pedal travel simulator (4) comprises two spatially separated units (14, 24) which are arranged in a common housing (5), the first unit (14) forming the first simulator space (16) and the simulator piston (18), and the second unit (24) forming the second simulator space (26) and the elastically deformable diaphragm (32).

7. The pedal travel simulator as claimed in claim 1 further comprising in that the second simulator space (126) is arranged in a cavity of the simulator piston (118), in a region of the simulator piston (118), which region lies opposite the restoring means (119).

8. The pedal travel simulator as claimed in claim 7 further comprising in that the second simulator space (126) is delimited by the diaphragm (132) which is arranged in the simulator piston (118) and a piston face cover (133) of the simulator piston (118), which piston face cover (133) is affixed to the simulator piston.

9. The pedal travel simulator as claimed in claim 8, further comprising in that a connecting channel (146) is arranged in the piston face cover (133), via which a connecting channel (146) and the second simulator space (126) is connected hydraulically to the first simulator space (116).

10. The pedal travel simulator as claimed in claim 8 further comprising in that a delimiting contour is formed on the piston face cover, against which delimiting contour the diaphragm bears substantially in a non-actuated state of the pedal travel simulator.

11. The pedal travel simulator as claimed in claim 7, further comprising in that a receiving space (127) is situated in the cavity of the simulator piston (118), the receiving space (127) is formed by the diaphragm (132) and a delimiting contour (134) which is formed in the simulator piston (118).

12. The pedal travel simulator as claimed in claim 11, further comprising in that the receiving space (127) is connected via at least one connecting channel (145) which is arranged in the simulator piston (118) to a space (117) which receives the elastic restoring means (119).

13. An actuating unit for a hydraulic motor-vehicle brake system of the brake-by-wire type comprising,
a brake master cylinder (3) which can be actuated by means of a brake pedal (1) with at least one pressure space (8, 9), to which wheel brakes can be connected (I, II) hydraulically, and
a pedal travel simulator (4, 104) having a housing (5, 30, 105) and a simulator piston (18, 118) which is mounted displaceably in the housing, the simulator piston delimiting together with the housing a first hydraulic simulator space (16, 116) which can receive a pressure medium, the simulator piston (18, 118) being loaded by an elastic restoring means (19, 119), a second hydraulic simulator space (26, 126) for receiving pressure medium, which second hydraulic simulator space (26, 126) is delimited by an elastically deformable diaphragm (32, 132).
by way of which a restoring force which acts on the brake pedal (1) is simulated in the brake-by-wire operating mode, in which the first and the second simulator space (16, 26; 116, 126) are connected hydraulically to the pressure space (8) of the brake master cylinder (3).

14. The actuating unit as claimed in claim 13, further comprising in that a switching device (15, 25) is provided in the hydraulic connection between the the first and the second simulator space (16, 26; 116, 126), which switching device (15, 25) connects the first and the second simulator space in the brake-by-wire operating mode to the brake master cylinder (3) and disconnects the connection outside the brake-by-wire operating mode, the switching device being formed by an electrically actuable adding valve (15) which is closed in a de-energized state, and a nonreturn valve (25) which is connected in parallel to the adding valve and opens in the direction of the brake master cylinder (3).

15. A hydraulic motor-vehicle brake system which, is operable in a brake-by-wire operating mode, can be actuated both by the vehicle driver and independently of the vehicle driver, is preferably operated in the brake-by-wire operating mode and can be operated in at least one fallback operating mode by the vehicle driver, comprising:
a brake master cylinder (3) which can be actuated by means of a brake pedal (1) with at least one pressure space (8, 9), to which wheel brakes are connected hydraulically,
an electrically controllable pressure source, by means of which the wheel brakes can be loaded with pressure, and which can be connected hydraulically, in particular, to each of the wheel brakes, and
a pedal travel simulator (4, 104) having a housing (5, 30, 105) and a simulator piston (18, 118) which is mounted displaceably in the housing, the simulator piston delimiting together with the housing a first hydraulic simulator space (16, 116) which can receive a pressure medium, the simulator piston (18, 118) being loaded by an elastic restoring means (19, 119), a second hydraulic simulator space (26, 126) for receiving pressure medium, which second hydraulic simulator space (26, 126) is delimited by an elastically deformable diaphragm (32, 132).
by way of which the vehicle driver is imparted a pleasant haptic brake pedal feeling in the brake-by-wire operating mode, in which the first and the second simulator space (16, 26; 116, 126) are connected hydraulically to the pressure space (8) of the brake master cylinder (3).
